(19) United States
(12) Patent Application Publication
(10) Pub. No.: US 2014/0274369 A1
(43) Pub. Date: Sep. 18, 2014

(54) SCHEME FOR ASSISTING IN CATCHING AN OBJECT IN A COMPUTER SIMULATION

(71) Applicant: SONY COMPUTER ENTERTAINMENT AMERICA LLC, Foster City, CA (US)

(72) Inventor: Kirby ST. JOHN, San Diego, CA (US)

(21) Appl. No.: 13/797,949

(22) Filed: Mar. 12, 2013

(51) Int. Cl. A63F 13/20

(52) U.S. Cl. CPC A63F 13/06
USPC 463/31

(57) ABSTRACT

A method includes displaying a character on a display, wherein movements of the character are controllable by a user, displaying an object on the display and causing the object to appear to be flying through the air, and displaying a first visual indicator on the display that visually indicates to the user which direction the character should move in order to get closer to a catch region where the character will be able to catch the object. A non-transitory computer readable storage medium stores one or more computer programs, and a system includes a display and a processor based apparatus.

### BACKGROUND OF THE INVENTION

1. Field of the Invention

The present invention relates generally to computer software applications, and more specifically to computer simulations, computer games, and video games.

2. Discussion of the Related Art

Computer games, such as video games, have become a popular source of entertainment. Computer games are typically implemented in computer game software applications and are often run on game consoles, entertainment systems, desktop, laptop, and notebook computers, portable devices, pad-like devices, etc.

Computer games are one type of computer simulation. The user of a computer game is typically able to view the game play on a display and control various aspects of the game with a game controller, game pad, joystick, mouse, or other input devices and/or input techniques.

### SUMMARY OF THE INVENTION

One embodiment provides a non-transitory computer readable storage medium storing one or more computer programs adapted to cause a processor based system to execute steps comprising: displaying a character on a display, wherein movements of the character are controllable by a user; displaying an object on the display and causing the object to appear to be flying through the air; and displaying a first visual indicator on the display that visually indicates to the user which direction the character should move in order to get closer to a catch region where the character will be able to catch the object.

Another embodiment provides a method, comprising: displaying, by a processor based apparatus, a character on a display, wherein movements of the character are controllable by a user; displaying an object on the display and causing the object to appear to be flying through the air; and displaying a first visual indicator on the display that visually indicates to the user which direction the character should move in order to get closer to a catch region where the character will be able to catch the object.

Another embodiment provides a system, comprising: a display; and a processor based apparatus that is configured to display a character on the display, wherein movements of the character are controllable by a user, display an object on the display and cause the object to appear to be flying through the air, and display a first visual indicator on the display that visually indicates to the user which direction the character should move in order to get closer to a catch region where the character will be able to catch the object.

A better understanding of the features and advantages of various embodiments of the present invention will be obtained by reference to the following detailed description and accompanying drawings which set forth an illustrative embodiment in which principles of embodiments of the invention are utilized.

### BRIEF DESCRIPTION OF THE DRAWINGS

The above and other aspects, features and advantages of embodiments of the present invention will be more apparent from the following more particular description thereof, presented in conjunction with the following drawings wherein:

FIGS. 1, 2, 3, and 4 are screen shots illustrating a method in accordance with an embodiment of the present invention;

FIG. 5 is a flow diagram illustrating a method in accordance with an embodiment of the present invention; and

FIG. 6 is a block diagram illustrating a computer or other processor based apparatus/system that may be used to run, implement and/or execute any of the methods and techniques shown and described herein in accordance with the embodiments of the present invention.

### DETAILED DESCRIPTION

Sports video games are a popular type of computer game. Sports video games simulate the practice of traditional sports, such as for example, baseball, football, basketball, soccer, hockey, etc. The players in a sports video game may be represented by animated characters and/or avatars on the display screen. The user of such a game is typically able to control various aspects of the game play, such as an individual player or an entire team.

By way of example, the user of a sports video game is often able to control a player avatar in the game so as to catch a ball or other object. For example, in a baseball video game the user is often able to control a player avatar to catch a baseball, such as a fly ball. In a football video game the user is often able to control a player avatar to catch a football, such as a pass from the quarterback or a kick off. Such games are similar to first-person games, except that in some cases the user is able to see and/or view more of the player avatar than is typically seen in many first-person games.

Computer games sometimes include features that assist a user in performing a particular action. Some of the embodiments of the present invention provide a feature that assists a user in controlling a character, such as a player in a sports video game, so as to catch an object, such as a ball. By way of example, some embodiments of the present invention may be used to provide a fly ball assist indicator in a baseball video game that can help the user get his or her player into position to catch the baseball. The use of embodiments of the present invention in baseball video games is just one example and it should be understood that embodiments of the present invention may be used in many other types of sports video games as well as many other types of computer games.

The following discussion will focus on an example embodiment of the present invention that is used to provide a fly ball assist indicator in a baseball video game. Specifically, in some embodiments the user controls a player avatar that is playing one of the fielding positions. In some embodiments the user control may comprise first-person control or be similar to first-person control. In some embodiments the fly ball assist indicator may comprise a first-person user catch mode mechanic. But use of the first-person mode is not required.

When the batter avatar hits the ball, the user controls his or her player in an attempt to make the player catch the ball. In some embodiments, the user must cause the player to move to a catch region, which is a region or location on the field where the player will be able to catch the ball. Namely, the catch region is a region located at or near where the ball will first hit the ground after flying. As such, the player will be able to catch the ball at or near the catch region. In some embodiments, the catch region is determined by factors that include the speed, height, and trajectory of the ball. In some embodiments, a catch region visual indicator is displayed to identify the location of the catch region for the user. The catch region visual indicator identifying the location of the catch region is an optional feature and even if it is displayed it may not always be visible to the user depending on the location of the player and the camera orientations.

In some embodiments, the fly ball assist indicator displays a fly ball assist visual indicator on the display that the user will see and that will point the user toward the catch region. In some embodiments the visual indicator is a type of mechanic that can help the user control his or her player in such a way as to move the player to the location of the catch region. In some embodiments, the visual indicator comprises an outfielder mechanic that can help the user estimate the trajectory of the baseball. In some embodiments, the visual indicator comprises an outfielder mechanic that can tell the user the trajectory of the baseball.

In some embodiments, the fly ball assist visual indicator can also provide the user with an indication as to how far the player is located from the catch region. For example, in some embodiments, the visual indicator changes colors as the player gets closer to the catch region. In some embodiments, the color of the visual indicator changes from red, to yellow, to green, as the player gets closer to the catch region. In some embodiments, the visual indicator eventually disappears once the player is encamped and ready to make the catch.

Referring to FIG. 1, there is illustrated a screen shot illustrating the operation of a fly ball assist indicator in accordance with an embodiment of the present invention. A display 100 displays a scene in a baseball video game that is viewed by a user (not shown). A baseball player 102 is shown in the outfield 104. The user's view is from just behind the player 102 looking towards the infield 106, the pitcher's mound 108, and the audience stands 110. The movements of the player 102 are controllable by the user via any type of controls means, such as for example a game controller, game pad, etc.

As shown, a baseball 112 has just been hit by a batter and the baseball 112 is flying through the air. An optional catch region visual indicator 114 is displayed to identify the location of the catch region. In some embodiments, the catch region visual indicator 114 comprises a generally or roughly circular spot on the field as shown. But the catch region visual indicator 114 can be any shape or color or any type of means at any location for identifying the location of the catch region.

A fly ball assist visual indicator 116 is also displayed on the display 100. The visual indicator 116 visually indicates to the user which direction the player 102 should move in order to get closer to the catch region where the player 102 will be able to catch the baseball 112. In the illustrated embodiment the visual indicator 116 comprises a partial moon-like shape having a pointer 118, but any shape may be employed. The pointer 118 points in the direction that the player 102 should move in order to get to the catch region, the location of which is indentified by the visual indicator 114. The pointer 118 helps the user know which direction the player 102 should move in order to get to the catch region. The pointer 118 may comprise any shape or any type of means for indicating to the user which direction the player 102 should move in order to get closer to the catch region.

The fly ball assist visual indicator 116 may be located anywhere on the display 100. In some embodiments, the fly ball assist visual indicator 116 may be positioned in a location on the display 100 that is easy for the user to see and/or that further helps the user know which direction the player 102 should move in order to get to the catch region.

As shown in FIG. 1, the player 102 is located a long distance from the catch region (the location of which is indentified by the visual indicator 114). In some embodiments, the fly ball assist visual indicator 116 further provides to the user an indication as to how far the player 102 is located from the catch region. In some embodiments, the indication as to how far the player 102 is located from the catch region comprises a color of the visual indicator 116. For example, in some embodiments the fly ball assist visual indicator 116 may be displayed in a first color to indicate to the user that the player 102 is far away or a long distance from the catch region. This will indicate to the user that the player 102 should be moved rapidly in the direction of the pointer 118 in order to get to the catch region in time to catch the baseball 112. For illustration purposes, the first color of the fly ball assist visual indicator 116 is illustrated with cross-hatching. By way of example, in some embodiments the first color may comprise red. But it should be understood that the first color may comprise any color, texture, pattern, look, etc.

In some embodiments, the indication as to how far the player 102 is located from the catch region comprises the visual indicator 116 changing colors as the player 102 moves closer to the catch region. This is illustrated in FIG. 2. As illustrated, the baseball 112 has flown farther, and meanwhile the user has made the player 102 move closer to the catch region (the location of which is indentified by the visual indicator 114). As such, the fly ball assist visual indicator 116 is now displayed in a second color to indicate that the player 102 is located an intermediate distance from the catch region. This will indicate to the user that the player 102 still needs to move somewhat rapidly in the direction of the pointer 118 in order to get to the catch region in time to catch the baseball 112, but that the user should be ready to slow down the player 102's movement so as to not overshoot the catch region. For illustration purposes, the second color of the fly ball assist visual indicator 116 is illustrated with single-hatching. By way of example, in some embodiments the second color may comprise yellow. But it should be understood that the second color may comprise any color, texture, pattern, look, etc.

In FIG. 3 both the player 102 and the baseball 112 have moved even closer to the catch region. As such, the fly ball assist visual indicator 116 is now displayed in a third color to indicate that the player 102 is located a short distance from the catch region. This will indicate to the user that the player 102 should now slow down in order to avoid overshooting the catch region. Furthermore, the user should get ready to control the player 102 in such a way as to catch the baseball 112. For illustration purposes, the third color of the fly ball assist visual indicator 116 is illustrated with no hatching. By way of example, in some embodiments the third color may comprise green. But it should be understood that the third color may comprise any color, texture, pattern, look, etc.

In FIG. 4 the player 102 is now located within the catch region or within a predetermined distance from the catch region. This is illustrated by the player 102 being very close to, or located on, the visual indicator 114. In some embodiments, the fly ball assist visual indicator 116 will disappear, as illustrated. The visual indicator 116 disappears because the player is now in a good position to catch the baseball 112. As such, the user should use the provided control over the player 102 to make the player 102 catch the baseball 112.

Thus, the fly ball assist visual indicator 116 can help players get into position to catch a fly ball. It points players towards an optimal catch position, and in some embodiments it will change from red to yellow to green as the player gets closer to the catch region. In some embodiments, the visual indicator 116 will disappear once the player is in a good position to catch the ball. In some embodiments, when used in single player mode or career mode, the fly ball assist visual indicator 116 is believed to enhance the experience of playing as a single player on the baseball field and enhance the single player experience in general. In some embodiments, the fly ball assist visual indicator 116 may be used in a first-person game or mode, or be used in a game or mode that is similar to first-person control.

Referring to FIG. 5, there is illustrated an example of a method 500 that operates in accordance with an embodiment of the present invention. The method 500 may be used for providing a feature that assists a user in controlling a character in a computer game so as to make the character catch an object. The method 500 may be used in any type of computer game, video game, sports video game, etc. Furthermore, the method 500 may be used in any mode of such games. For example, the method 500 may be used in a single player mode, a career mode, team mode, franchise mode, etc. Furthermore, in some embodiments the feature provided by the method 500 may include means for allowing the feature to be enabled or disabled by the user. This means the user can decide if he or she wants the assistance provided by the method 500 or if he or she does not want the assistance in order to provide more of a challenge.

The method 500 begins in step 502 in which a character is displayed on a display. The movements of the character are controllable by a user. In some embodiments the character comprises a player, such as a player in a sports video game.

In step 504 an object is displayed on the display. The object is made to move so as to cause it to appear to be flying through the air. In some embodiments the object comprises a ball. For example, in some embodiments the object may appear to be a baseball that has been batted by a baseball player.

In step 506 a first visual indicator is displayed on the display. The first visual indicator visually indicates to the user which direction the character should move in order to get closer to a catch region where the character will be able to catch the object. In some embodiments, such visual indication is performed by the first visual indicator pointing in the direction that the character should be moved in order to get closer to the catch region. In some embodiments, this may comprise the first visual indicator pointing to the catch region.

In some embodiments, the first visual indicator further provides to the user an indication as to how far the character is from the catch region. In some embodiments, this indication comprises a color of the first visual indicator, and in some embodiments, this indication comprises the first visual indicator changing colors as the character moves closer to the catch region. In some embodiments, this indication comprises the first visual indicator being displayed in a first color when the character is located a long distance from the catch region, a second color when the character is located an intermediate distance from the catch region, and a third color when the character is located a short distance from the catch region. In some embodiments, the first visual indicator disappears when the character is located within a predetermined distance from the catch region, or in some embodiments the first visual indicator disappears when the character is located within the catch region.

In step 508 a second visual indicator is displayed on the display. The second visual indicator identifies the catch region for the user. The second visual indicator may comprise any type of means for identifying the catch region. For example, the second visual indicator may comprise any shape or color and be located anywhere on the display. Furthermore, the second visual indicator is an optional feature and even when it is used it may not always be visible to the user.

The methods and techniques described herein may be utilized, implemented and/or run on many different types of processor based apparatuses or systems. For example, the methods and techniques described herein may be utilized, implemented and/or run on computers, servers, game consoles, entertainment systems, portable devices, pad-like devices, etc. Furthermore, the methods and techniques described herein may be utilized, implemented and/or run in online scenarios or networked scenarios, such as for example, in online games, online communities, over the Internet, etc.

Referring to FIG. 6, there is illustrated an example of a processor based apparatus or system 600 that may be used for any such implementations. One or more components of the processor based apparatus or system 600 may be used for implementing any method, system, or device mentioned above, such as for example any of the above-mentioned computers, servers, game consoles, entertainment systems, portable devices, pad-like devices, etc. However, the use of the processor based apparatus or system 600 or any portion thereof is certainly not required.

By way of example, the system 600 may include, but is not required to include, a central processing unit (CPU) 602, a graphics processing unit (GPU) 604, a random access memory (RAM) 608, and a mass storage unit 610, such as a disk drive. The system 600 may be coupled to, or integrated with, any of the other components described herein, such as a display 612 and/or an input device 616. In some embodiments, the system 600 comprises an example of a processor based apparatus or system. In some embodiments, such a processor based apparatus or system may also be considered to include the display 612 and/or the input device 616. The CPU 602 and/or GPU 604 may be used to execute or assist in executing the steps of the methods and techniques described herein, and various program content, images, avatars, characters, players, menu screens, video games, virtual worlds, graphical user interface (GUI), etc., may be rendered on the display 612.

The input device 616 may comprise any type of input device or input technique or method. For example, the input device 616 may comprise a game controller, game pad, joystick, mouse, wand, or other input devices and/or input techniques. The input device 616 may be wireless or wired, e.g. it may be wirelessly coupled to the system 600 or comprise a wired connection. In some embodiments, the input device 616 may comprise means or sensors for sensing and/or tracking the movements and/or motions of a user and/or an object controlled by a user. The display 612 may comprise any type of display or display device or apparatus.

The mass storage unit 610 may include or comprise any type of computer readable storage or recording medium or media. The computer readable storage or recording medium or media may be fixed in the mass storage unit 610, or the mass storage unit 610 may optionally include removable storage media 614, such as a digital video disk (DVD), Blu-ray disc, compact disk (CD), USB storage device, floppy disk, or other media. By way of example, the mass storage unit 610 may comprise a disk drive, a hard disk drive, flash memory device, USB storage device, Blu-ray disc drive, DVD drive, CD drive, floppy disk drive, etc. The mass storage unit 610 or removable storage media 614 may be used for storing code or macros that implement the methods and techniques described herein.

Thus, removable storage media 614 may optionally be used with the mass storage unit 610, which may be used for storing program or computer code that implements the methods and techniques described herein, such as program code for running the above-described methods and techniques. However, any of the storage devices, such as the RAM 608 or mass storage unit 610, may be used for storing such code. For example, any of such storage devices may serve as a tangible non-transitory computer readable storage medium for storing or embodying a computer program or software application for causing a console, system, computer, client, server, or other processor based apparatus or system to execute or perform the steps of any of the methods, code, and/or techniques described herein. Furthermore, any of the storage devices, such as the RAM 608 or mass storage unit 610, may be used for storing any needed database(s).

In some embodiments, one or more of the embodiments, methods, approaches, and/or techniques described above may be implemented in one or more computer programs or software applications executable by a processor based apparatus or system. By way of example, such processor based system may comprise the processor based apparatus or system 600, or a computer, entertainment system, game console, graphics workstation, server, client, portable device, pad-like device, etc.

Such computer program(s) may be used for executing various steps and/or features of the above-described methods and/or techniques. That is, the computer program(s) may be adapted to cause or configure a processor based apparatus or system to execute and achieve the functions described above. For example, such computer program(s) may be used for implementing any embodiment of the above-described methods, steps, techniques, or features. As another example, such computer program(s) may be used for implementing any type of tool or similar utility that uses any one or more of the above described embodiments, methods, approaches, and/or techniques. In some embodiments, one or more such computer programs may comprise a computer game, video game, role-playing game (RPG), other computer simulation, or system software such as an operating system, BIOS, macro, or other utility. In some embodiments, program code macros, modules, loops, subroutines, calls, etc., within or without the computer program(s) may be used for executing various steps and/or features of the above-described methods and/or techniques. In some embodiments, the computer program(s) may be stored or embodied on a computer readable storage or recording medium or media, such as any of the computer readable storage or recording medium or media described herein.

Therefore, in some embodiments the present invention provides a computer program product comprising a medium for embodying a computer program for input to a computer and a computer program embodied in the medium for causing the computer to perform or execute steps comprising any one or more of the steps involved in any one or more of the embodiments, methods, approaches, and/or techniques described herein. For example, in some embodiments the present invention provides one or more non-transitory computer readable storage mediums storing one or more computer programs adapted to cause a processor based apparatus or system to execute steps comprising: displaying a character on a display, wherein movements of the character are controllable by a user; displaying an object on the display and causing the object to appear to be flying through the air; and displaying a first visual indicator on the display that visually indicates to the user which direction the character should move in order to get closer to a catch region where the character will be able to catch the object.

While the invention herein disclosed has been described by means of specific embodiments and applications thereof, numerous modifications and variations could be made thereto by those skilled in the art without departing from the scope of the invention set forth in the claims.

What is claimed is:

1. A non-transitory computer readable storage medium storing one or more computer programs adapted to cause a processor based system to execute steps comprising:
displaying a character on a display, wherein movements of the character are controllable by a user;
displaying an object on the display and causing the object to appear to be flying through the air; and
displaying a first visual indicator on the display that visually indicates to the user which direction the character should move in order to get closer to a catch region where the character will be able to catch the object.

2. The non-transitory computer readable storage medium of claim 1, wherein the first visual indicator visually indicates to the user which direction the character should move in order to get closer to a catch region by pointing.

3. The non-transitory computer readable storage medium of claim 1, wherein the first visual indicator further provides to the user an indication as to how far the character is from the catch region.

4. The non-transitory computer readable storage medium of claim 3, wherein the indication as to how far the character is from the catch region comprises a color of the first visual indicator.

5. The non-transitory computer readable storage medium of claim 3, wherein the indication as to how far the character is from the catch region comprises the first visual indicator changing colors as the character moves closer to the catch region.

6. The non-transitory computer readable storage medium of claim 3, wherein the indication as to how far the character is from the catch region comprises the first visual indicator being displayed in a first color when the character is located a long distance from the catch region, a second color when the character is located an intermediate distance from the catch region, and a third color when the character is located a short distance from the catch region.

7. The non-transitory computer readable storage medium of claim 1, wherein the first visual indicator disappears when the character is located within a predetermined distance from the catch region.

8. The non-transitory computer readable storage medium of claim 1, wherein the first visual indicator disappears when the character is located within the catch region.

9. The non-transitory computer readable storage medium of claim 1, wherein the one or more computer programs are further adapted to cause the processor based system to execute steps comprising:
displaying a second visual indicator on the display that identifies the catch region.

10. The non-transitory computer readable storage medium of claim 1, wherein the character comprises a player in a sports video game.

11. The non-transitory computer readable storage medium of claim 1, wherein the object comprises a ball.

12. A method, comprising:
displaying, by a processor based apparatus, a character on a display, wherein movements of the character are controllable by a user;
displaying an object on the display and causing the object to appear to be flying through the air; and
displaying a first visual indicator on the display that visually indicates to the user which direction the character should move in order to get closer to a catch region where the character will be able to catch the object.

13. A system, comprising:
a display; and
a processor based apparatus that is configured to display a character on the display, wherein movements of the character are controllable by a user, display an object on the display and cause the object to appear to be flying through the air, and display a first visual indicator on the display that visually indicates to the user which direction the character should move in order to get closer to a catch region where the character will be able to catch the object.
